(19) United States
(12) Patent Application Publication
(10) Pub. No.: US 2010/0260444 A1
(43) Pub. Date: Oct. 14, 2010

(54) REINFORCED BAG

(76) Inventors: Vir Narula, North Haledon, NJ (US); Michael Hieger, Allentown, PA (US)

Correspondence Address: STANLEY H. KREMEN, 4 LENAPE LANE, EAST BRUNSWICK, NJ, 08816, US

(21) Appl. No.: 12/823,103

(22) Filed: Jun. 24, 2010

(51) Int. Cl. B65D 33/02; B31B 41/74

(52) U.S. Cl. 383/119; 493/210

(57) ABSTRACT

A method of reinforcing a multi-wall bag, such as one used to hold particles or powder using corrugated or fluted cardboard inserts as well as the reinforced bag itself. The inserts are preferably constructed from flat cardboard, but may be constructed from plastic or any other suitable material. The inserts may remain flat, or they may be scored perpendicular to the flute direction in such a way as to bend when pressure is applied along the flute direction. The scoring does not penetrate through the entire depth of the cardboard. The inserts may be inserted either along the sides of the bag or along both the sides and bottom of the bag.

### BACKGROUND OF THE INVENTION

Single or multi-wall bags holding particulates or powder have certain advantages over corrugated boxes. However, such bags do not have the structural compression strength required to bear weight.

The solution to this problem is to create a package that has most of the advantages of a bag but with the strength of a corrugate. The objective is to have the advantages of economical manufacture, transportation, and filling the final product in the package. The reinforced bags of the Present Invention are designed to achieve all these advantages.

Normally empty bags are manufactured by bag manufacturers, stacked in collapsed form in bundles on pallets, and shipped to the product manufacturer. The empty bags are stacked in the filling machine magazine, and product fills the bag. The bag is then sealed.

There is no structural support built into the bag to take the entire weight caused by stacking the filled bags, one bag on top of the other on a pallet. Furthermore, many filled pallets are stacked on top of one another. Therefore, products that are soft, breakable, crushable, or collapsible are not suitable to be packaged into bags.

### BRIEF DESCRIPTION OF THE DRAWINGS

FIG. 1 illustrates a flat bottom, single or multi-wall bag reinforced by a U-shaped corrugated liner.

FIG. 1A is a front elevation of the bag.

FIG. 1B is a top plan view of the bag.

FIG. 1C is a side elevation of the bag.

FIG. 2 shows an isometric schematic of the U-shaped liner and its relation to the bag.

FIG. 3 illustrates a single or multi-wall gusseted bag reinforced by slightly bent corrugated strips inserted only along the sides of the bag.

FIG. 3A is an isometric exploded view showing how the bent inserts are inserted into the bag.

FIG. 3B is a front elevation of the filled bag.

FIG. 3C is a top plan view of the filled bag.

FIG. 3D is a side elevation of the filled bag.

FIG. 3E is a top plan view of the unfilled or partially filled bag.

FIG. 3F is a side elevation of the unfilled or partially filled bag.

FIG. 3G is an isometric break out view of the inside of the reinforced bag.

FIG. 4 illustrates a single or multi-wall gusseted bag without a tear strip reinforced by slightly bent corrugated inserts along the sides as well as a bottom liner.

FIG. 4A is an isometric exploded view showing different types of bent inserts that can be used for reinforcement.

FIG. 4B is an isometric view of corrugated inserts having straight ends.

FIG. 4C is an isometric view of corrugated inserts having ends cut for a better fit in the bag.

FIG. 4E is a front elevation of the bag.

FIG. 4F is a top plan view of the filled bag.

FIG. 4G is a side elevation of the filled bag.

FIG. 4H is a top plan view of the unfilled or partially filled bag.

FIG. 4J is a side elevation of the unfilled or partially filled bag.

FIG. 4K is an isometric break out view of the inside of the reinforced bag.

FIG. 5 is an isometric schematic showing two corrugated elements both positioned outside the bag for reinforcement.

FIG. 6 is an isometric schematic showing two corrugated elements, one positioned inside the bag and the other positioned outside the bag.

FIG. 7 is an isometric schematic showing two corrugated elements, one positioned inside the bag and the other positioned outside the bag.

### SUMMARY OF THE INVENTION

The Present Invention discloses a method of reinforcing a multi-wall bag, such as one used to hold particles or powder using corrugated or fluted cardboard inserts as well as the reinforced bag itself. The inserts are preferably constructed from flat cardboard, but may be constructed from plastic or any other suitable material. The inserts may remain flat, or they may be scored perpendicular to the flute direction in such a way as to bend when pressure is applied along the flute direction. The scoring does not penetrate through the entire depth of the cardboard. The inserts may be inserted either along the sides of the bag or along both the sides and bottom of the bag.

### DETAILED DESCRIPTION OF THE INVENTION

The reinforced bags of the Present Invention are manufactured and shipped in collapsed form, and when filled, have a built in structural support inside the bags to protect the product and to support the weight of additional bags stacked (palletized) on top of them.

The method of the Present Invention involves attaching scored corrugated sheets (or other suitable materials) to the walls of the empty bag. The corrugated sheets are glued or otherwise secured to the inside surfaces of the empty bag. The score line on the corrugated sheet and the fold line of the empty bag coincides, thereby allowing bags to fold in collapsed fashion when empty. When the bag is empty and folded, the corrugated sheet also folds along the bag fold because there is a score/cut in the corrugated sheet.

When the bag is filled, the fluted portion of one side of the scored corrugate is aligned with the fluted portion of the other side of the scored corrugated sheet, to form a continuous fluted corrugated sheet providing sufficient structural strength to bear the load.

Normally, a corrugated sheet has three layers, viz., a fluted sheet sandwiched between two liner boards. A scored corrugated sheet has one liner board and the fluted sheet with score/sharp cut perpendicular to the flute direction, but with the last liner board intact. Similar results can be achieved by having two separate corrugated sheets attached to the bag walls on both sides of the fold line. The corrugated sheets are attached in such a way that there is no space between the two corrugated sheets when flat.

Once the bags are completely filled with product, the two side walls with the scored corrugate will have vertical flutes aligned, and these corrugated sheets will bear the load. The package can be stacked on a pallet, and the weight of the product will be carried by the corrugate walls rather than the product. The concept can be extended to three sides of the bag—two sides and one bottom. It can be used on all four sides with glue end bags.

Such bags will be economical compared to providing extra support to protect the product in each package; the bags can be used to provide stand up capabilities on the shelf because two or three sides has support/structure in it.

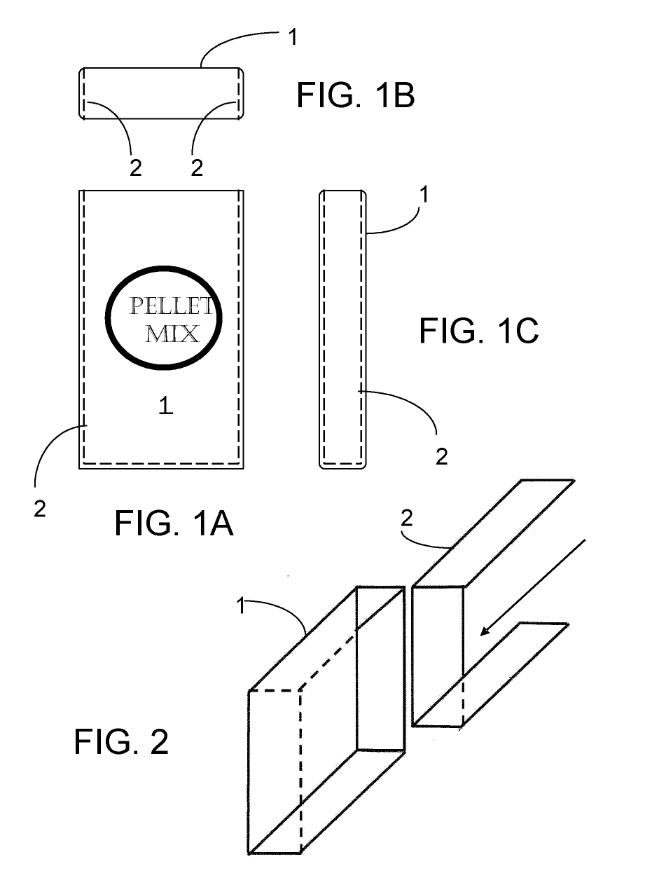

FIG. 1 shows a bag 1 reinforced by a U-shaped folded single corrugated sheet 2. The folds can be produced by scoring the sheet in two places in the manner described supra. FIGS. 1A, 1C, and 1B are front and side elevations and a top plan view of the reinforced bag, respectively. The folded U-shaped corrugate is inserted into the bag as shown in FIG. 2. In this case, while the bag has considerable strength when full of product, it is not collapsible.

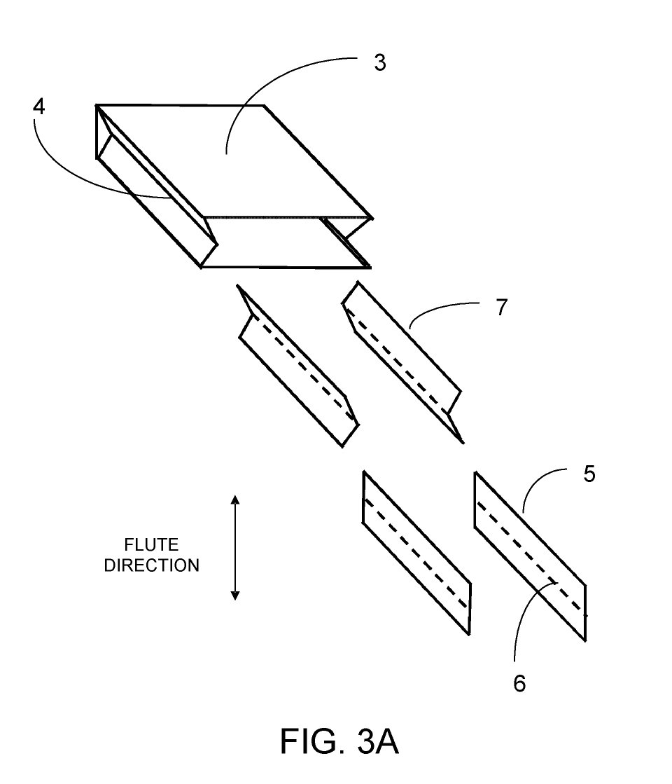

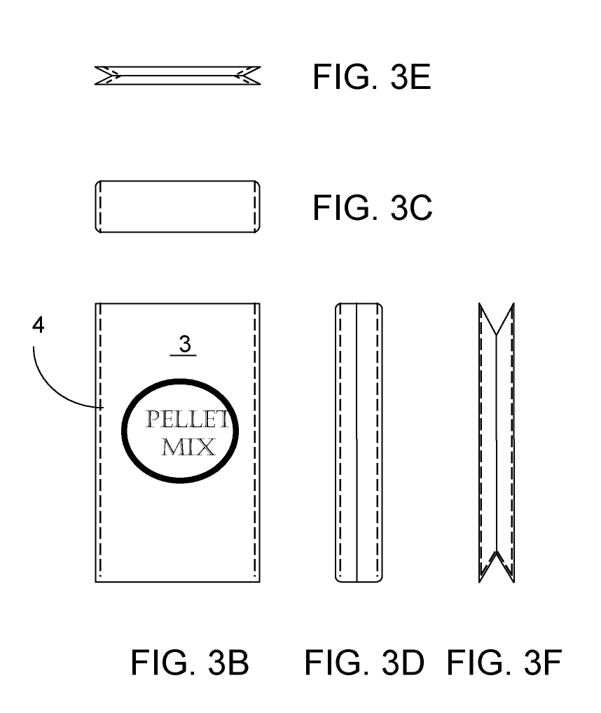

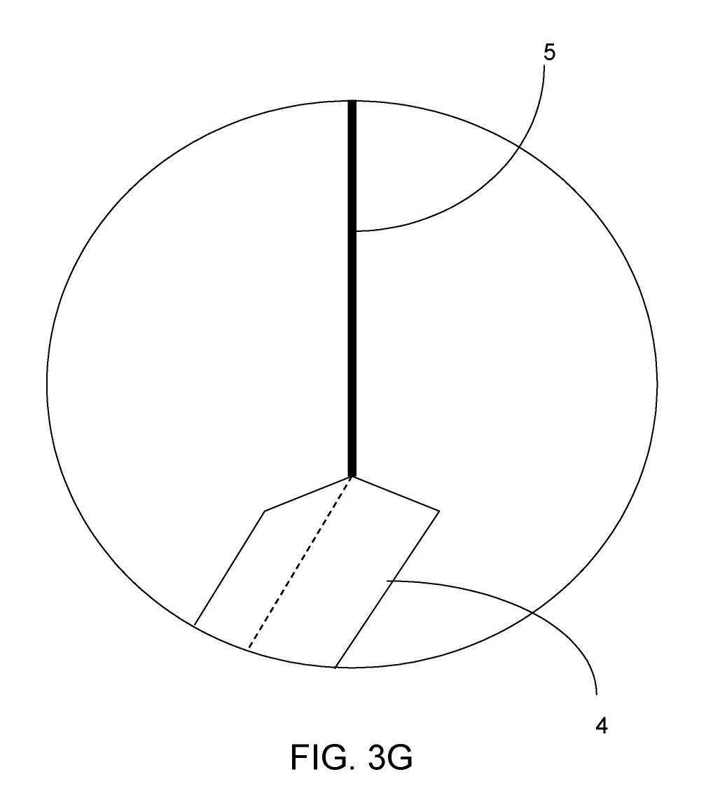

FIG. 3A shows how a gusseted bag 3 with a tear strip and fold lines 4 along its sides may be reinforced with corrugate inserts positioned along the sides of the bag. Two flat corrugated sheets 5 are scored 6 perpendicular to the flute direction. This allows the sheet 5 to fold into shaped corrugates 7 to be inserted into bag 3. The fold lines 6 in sheet 7 coincide with the fold lines 4 of bag 3. FIGS. 3B, 3D, and 3C are front and side elevations and a top plan view of the bag completely filled with product, respectively. FIGS. 3E and 3F are a top plan view and a side elevation of the reinforced bag 3, respectively, when empty or partially filled with product. FIG. 3G is a partial breakout isometric view showing a portion of the inside of the bag. The viewer is looking at the bottom seam 5 of the bag. The partially folded corrugate 4 rests against the side of the bag.

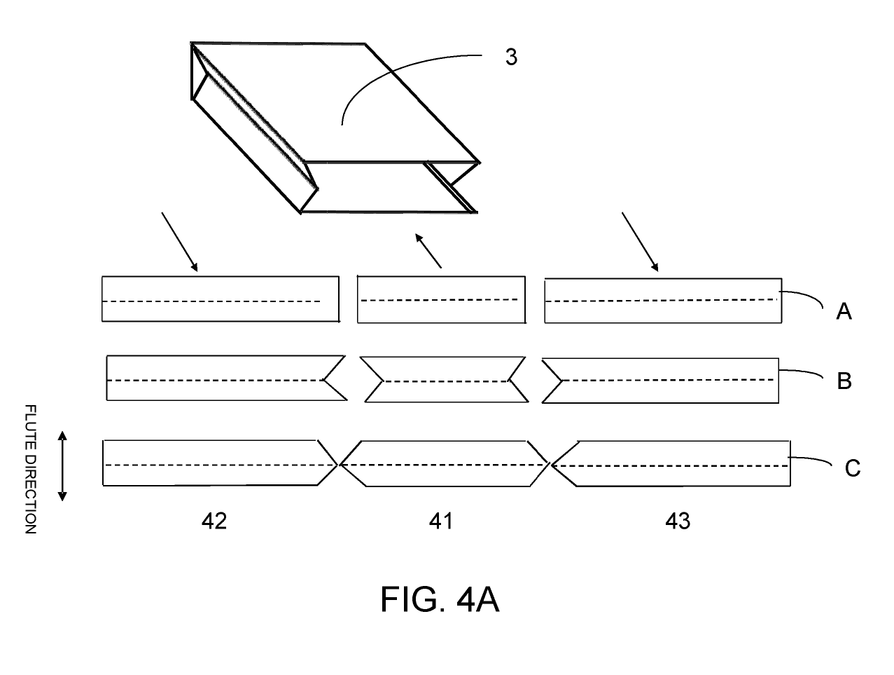

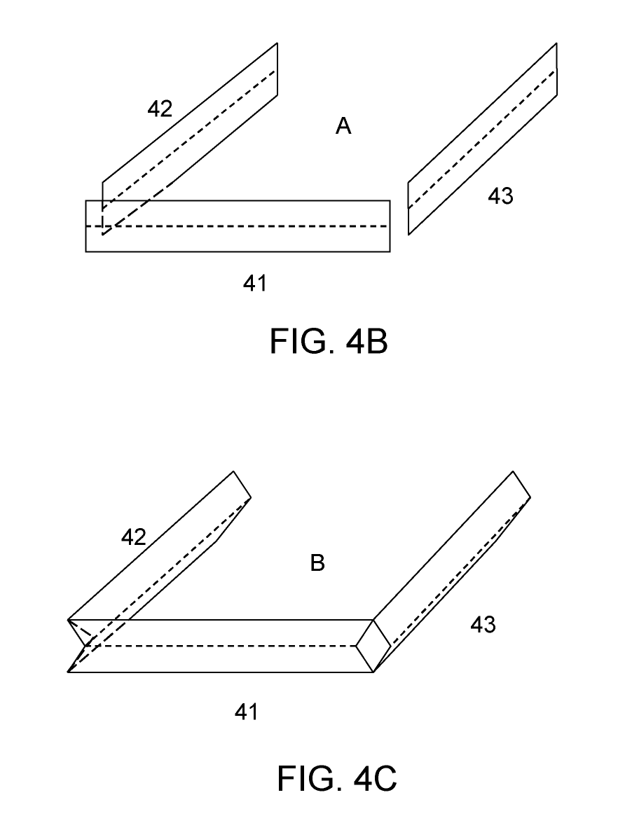

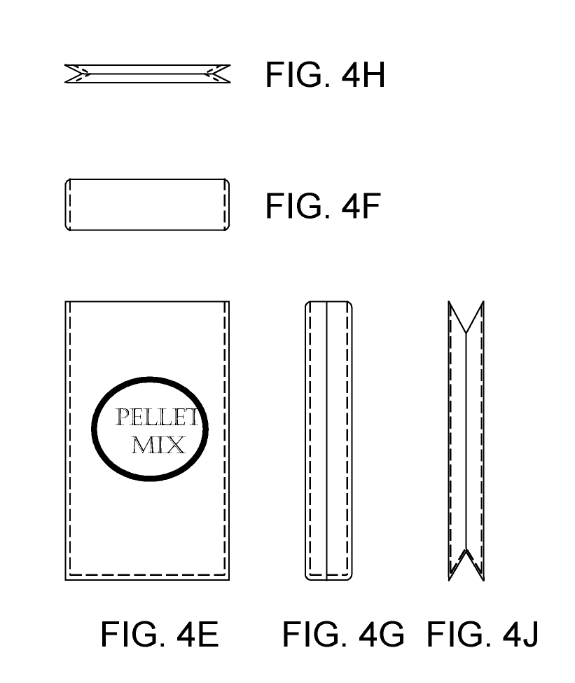

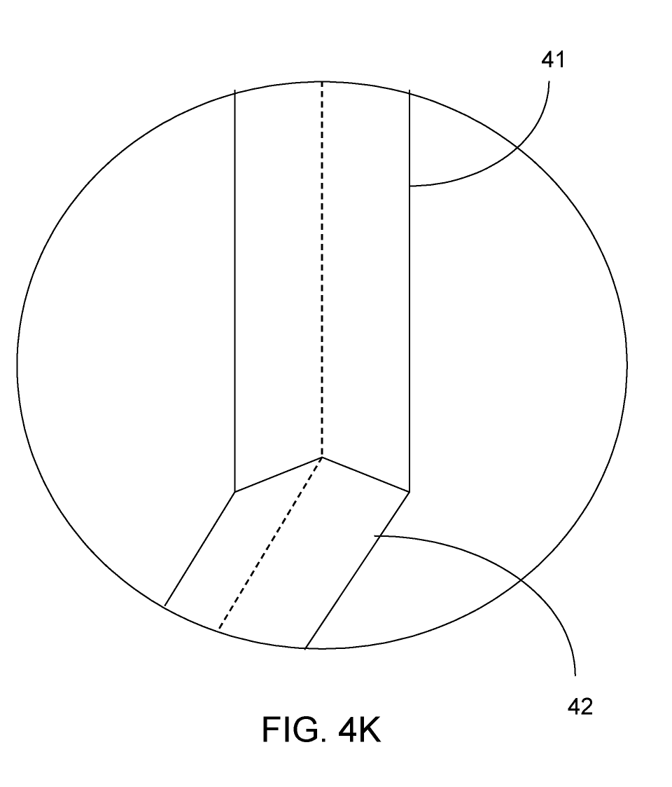

FIG. 4A is an isometric showing how a bottom corrugated sheet 41 may be inserted between the two side corrugated sheets, 42 and 43. Three different embodiments are shown in the figure. Embodiment A has flat cut ends. They fit together as shown in FIG. 4B. Clearly, there must be a gap between the side corrugates and the bottom corrugates or they will not fold properly. The other two embodiments have V-shaped cut ends. Embodiment B shows one type of end cut where the apex of the ‘V’ faces inward, while Embodiment C shows a different type of end cut, where the apex of the ‘V’ faces outward. FIG. 4C shows how the pieces of Embodiment B fit together. Clearly, this is an advantage over Embodiment A, since the bottom corners are reinforced. FIGS. 4E, 4F, and 4G show the bag completely filled with product, while FIGS. 4H and 4J show the bag empty or partially filled with product. FIG. 4K shows yet another embodiment. The drawing shows a partial isometric view of the inside of the bag. The viewer is looking toward the bottom of the bag. Corrugate 41 lies along the bottom, while corrugate 42 lies along the side. However, the end cut of corrugate 42 has the apex of the ‘V’ facing outward, while the end cut of corrugate 41 has the apex of the ‘V’ cut facing inward. This can be reversed. This embodiment provides the greatest structural stability where the apexes of the ‘V’ cuts of the side members 42 face opposite to the apexes of the ‘V’ cuts of the bottom member. This provides the closest packing of the reinforcement packing at the bottom corners of the bag.

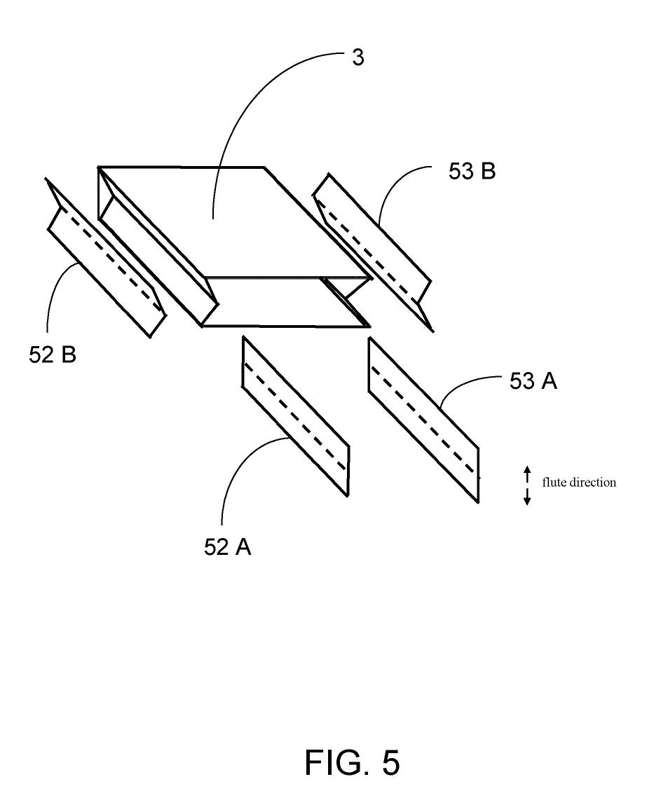

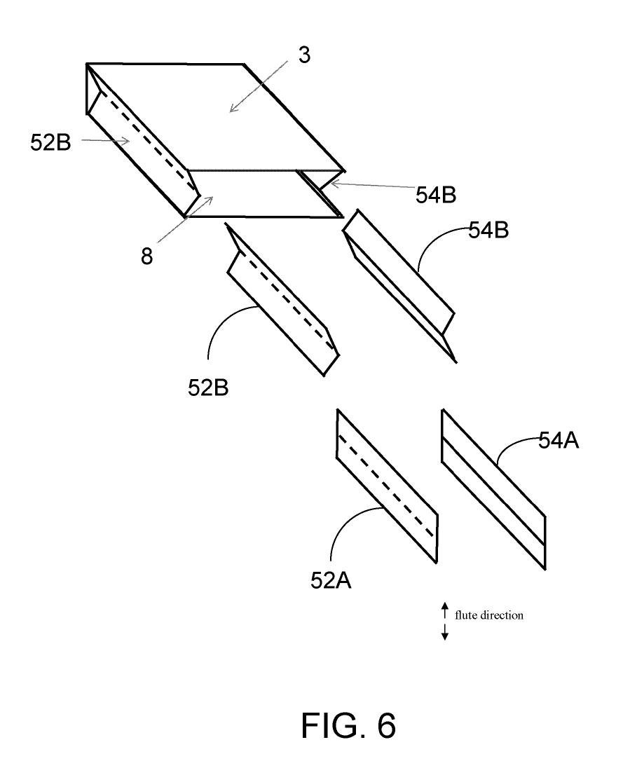

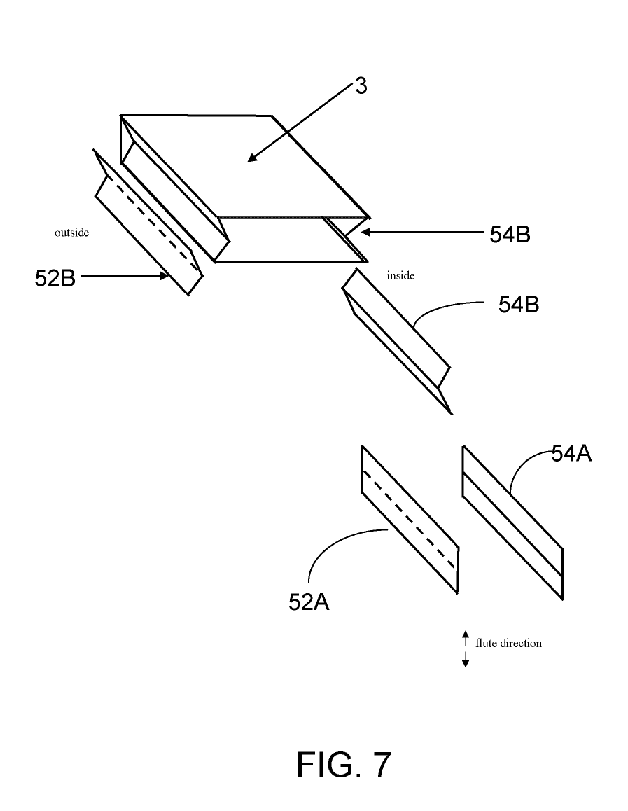

FIG. 5 shows an embodiment of the bag where both corrugates attach to the outside of the bag for reinforcement. Corrugate 52A is scored, folded, and placed on the outside left side of the bag as corrugate 52B, while corrugate 53A is scored and folded and placed on the outside right side of the bag. FIG. 6 shows a hybrid reinforcement scheme where corrugate 52B is placed on the outside left side of the bag (in the same way as shown in FIG. 5), but corrugate 54A is scored and folded as corrugate 54B and placed on the inside surface of the bag. FIG. 6 further shows that the bag may have a plastic or paper inside lining 8. FIGS. 6 and 7 illustrate that reinforcement is accomplished by placing the reinforcing elements on the inside or the outside of the bag in any combination.

I claim:

1. A method for reinforcing a bag to provide structural load bearing compressive strength, wherein the bag comprises an inside surface, sides, and a bottom, said method comprising:
a) cutting at least one essentially planar reinforcing material into a desired shape wherein said material is capable of bearing a desired force applied along the planar direction;
b) inserting the at least one essentially planar reinforcing material into the bag; and
c) securing the at least one essentially planar reinforcing material to the inside surface of the bag,
whereby the at least one essentially planar reinforcing material provides structural load bearing capability along its planar direction and prevents the bag from collapsing from the load.

2. The method of claim 1 wherein the at least one essentially planar reinforcing material is plastic or metal.

3. The method of claim 1 wherein the at least one essentially planar reinforcing material is a corrugated sheet comprising at least two layers, with at least one layer being essentially planar, and at least one layer comprising flutes.

4. The method of claim 2 wherein the at least one essentially planar reinforcing material has a single fold.

5. The method of claim 3 wherein the at least one essentially planar reinforcing material is scored in a direction perpendicular to the flute direction so as to leave at least one of the essentially planar layers unscored, and wherein the at least one essentially planar reinforcing material may be folded along the scored direction.

6. The method of claim 1 wherein a plurality of essentially planar reinforcing materials, each comprised of the at least one essentially planar reinforcing material, is inserted into the bag and secured to the inside surface of the bag.

7. The method of claim 6 wherein the number of the plurality of essentially planar reinforcing materials is two.

8. The method of claim 7 wherein the two essentially planar reinforcing materials are positioned parallel to each other on the inside surface of the bag so as to be on opposite sides of the bag.

9. The method of claim 6 wherein the number of the plurality of essentially planar reinforcing materials is three.

10. The method of claim 9 wherein the three essentially planar reinforcing materials are positioned such that two of them are parallel to each other and the third is essentially perpendicular to the other two, and wherein the two parallel essentially planar reinforcing materials are positioned parallel to each other on the inside surface of the bag so as to be on opposite sides of the bag, and the third perpendicular essentially planar reinforcing material is positioned on the inside surface of the bag so as to be on the bottom of the bag.

11. The method of claim 8 wherein two of the sides of the bag comprise fold lines, and said two sides are opposite each other.

12. The method of claim 11 wherein the two essentially planar reinforcing materials comprise fold lines, and are secured to the inside surface of the bag, such that said fold lines of the two essentially planar reinforcing materials essentially coincide with the fold lines on the two opposite sides of the bag.

13. The method of claim 10 wherein the two sides of the bag comprise fold lines, and said two sides are opposite each other, and the bottom of the bag comprises a fold line that is not coincident with the fold lines of either side.

14. The method of claim 13 wherein the three essentially planar reinforcing materials comprise fold lines, and are secured to the inside surface of the bag, such that said fold lines of two of the essentially planar reinforcing materials essentially coincide with the fold lines on the two opposite sides of the bag, and that said fold line of the third essentially planar reinforcing material essentially coincides with the fold line on the bottom of the bag.

15. A reinforced bag comprising an inside surface, sides, a bottom, and at least one essentially planar reinforcing material capable of bearing a desired force in its planar direction, wherein said at least one essentially planar reinforcing material is secured to the inside surface of the reinforced bag.

16. The reinforced bag of claim 15 comprising two essentially planar reinforcing materials that are secured to the inside surface of the bag so as to be on opposite sides of the bag.

17. The reinforced bag of claim 16 wherein the two essential planar reinforcing materials are all capable of folding along a single fold line such that the bag may collapse when empty of partially filled, but when the bag is filled to capacity, the two essentially planar reinforcing materials remain entirely essentially planar in an unfolded position.

18. The reinforced bag of claim 16 further comprising a third essentially planar reinforcing material that is secured to the inside surface of the bag so as to be on the bottom of the bag.

19. The reinforced bag of claim 18 wherein the three essential reinforcing planar materials are all capable of folding along a single fold line such that the bag may collapse when empty of partially filled, but when the bag is filled to capacity, the two essentially planar reinforcing materials remain entirely essentially planar in an unfolded position.
